(19) United States
(12) Patent Application Publication
(10) Pub. No.: US 2025/0210948 A1
(43) Pub. Date: Jun. 26, 2025

(54) METHODS AND SYSTEMS FOR STRIPPING INSULATION FROM CABLE

(71) Applicant: DISH Wireless L.L.C., Englewood, CO (US)

(72) Inventors: Jimmy A. Pollard, JR., Boiling Springs, SC (US); John Pye, Inman, SC (US)

(21) Appl. No.: 18/390,389

(22) Filed: Dec. 20, 2023

(51) Int. Cl. H02G 1/12

(52) U.S. Cl. CPC H02G 1/1256

(57) ABSTRACT

The system comprises a plurality of actuators, which are operable to receive instructions and coordinate an actuation sequence. The system comprises a clamping mechanism, including at least one of the plurality of actuators and at least one clamping block. The system comprises a cutting mechanism, which cuts an insulation layer of a multiple conductor cable and includes at least one cutting blade. The system may comprise a control system, which comprises a plurality of controllers, a non-transitory readable medium storing instructions. The control system may receive cable parameters of the multiple conductor cable, including cable diameter and conductor quantity. The control system may activate the clamping mechanism and cutting mechanism. The control system may cause the clamping mechanism to rotate about a pivot point. The control system may remove a section of insulation from the multiple conductor cable based on the rotation of the clamping mechanism.

### BACKGROUND

A wire stripper is a small, hand-held device that strips electrical insulation from electric wires. A simple manual wire stripper is a pair of opposing blades, much like scissors or wire cutters. The addition of a center notch makes it easier to cut the insulation without cutting the wire. This type of wire stripper is used by rotating it around the insulation while applying pressure in order to make a cut around the insulation. Since the insulation is not bonded to the wire, it pulls easily off the end. Once the device is clamped on, the remainder of the wire can simply be pulled out, leaving the insulation behind.

### BRIEF DESCRIPTION OF THE DRAWINGS

FIG. 1 is an outwardly facing perspective view of the cable stripping mechanism configured in accordance with the embodiments of the present technology.

FIG. 2 is an isometric perspective view of the clamping system 200 configured in accordance with the embodiments of the present technology.

FIG. 3 is an above-facing view of the cable stripping mechanism configured in accordance with the embodiments of the present technology.

FIG. 4 is a flow chart that illustrates the process of activating and performing the stripping mechanism.

FIG. 5 is a block diagram of a processing system that can implement operations of the disclosed embodiments.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to methods and systems for stripping insulation from a multiple conductor cable. When a cable is attached to a cable connecter, the insulation and outer layers need to first be stripped away. Commonly, cables contain multiple wires or conductors, where each conductor is coated in insulation. In some embodiments, the multiple wires contained in the cable have a large gauge or diameter, requiring large amounts of force to strip away the insulation. Stripping the insulation from large gauge wires with hand tools is tedious, while stripping the large gauge wire using an automatic stripping machine with electric motors will cause damage to the cutting blades and motor, preventing the automatic stripping machine's use.

The disclosed method utilizes actuators and a clamping mechanism to strip away the insulation from the cable without causing damage to the cable stripping machine. The cable stripping machine includes a series of actuators to perform the wire stripping process. For example, the method may include the use of pneumatic or hydraulic actuators. The system includes multiple clamping mechanisms. For example, the clamping mechanisms may include actuators to secure the cable in the system. The system includes a cutting mechanism. For example, the cutting mechanism may include actuators to cut the inner layer of insulation on the multiple wires contained in the cable.

The system may include a control system to coordinate the series of actuators to perform the stripping function. The control system activates multiple clamping mechanisms. The control system may activate an actuator, causing at least one clamping mechanism to rotate about a pivot point, causing the inner insulation layer to be stripped from the multiple wires.

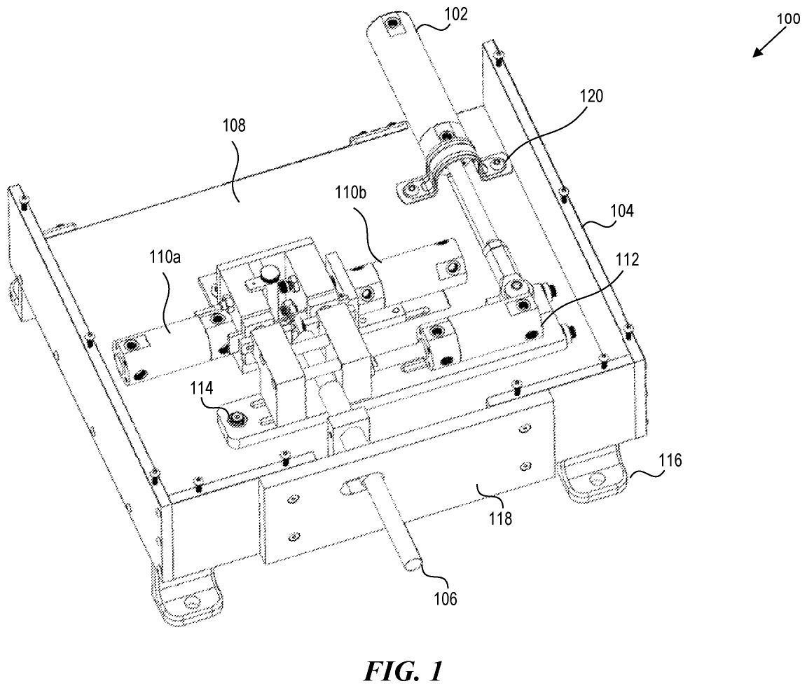

FIG. 1 is an outwardly facing perspective view of the cable stripping mechanism configured in accordance with the embodiments of the present technology. The cable stripping mechanism includes a mounting structure 108. The mounting structure 108 may couple to and/or be configured to contain a safety wall 104. The safety wall 104 may include a guiding plate 118. The guiding plate 118 may attach to the safety wall 104 and guide cable 106 into the cable stripping mechanism. In some embodiments, cable 106 contains multiple conductors. Cable 106 may include an outer insulation layer, a filler fiber layer, and multiple conductors surrounded by individual inner insulation layers. In some embodiments, the mounting structure 108 includes mounting feet 116 to mount the cable stripping mechanism to a table or the ground.

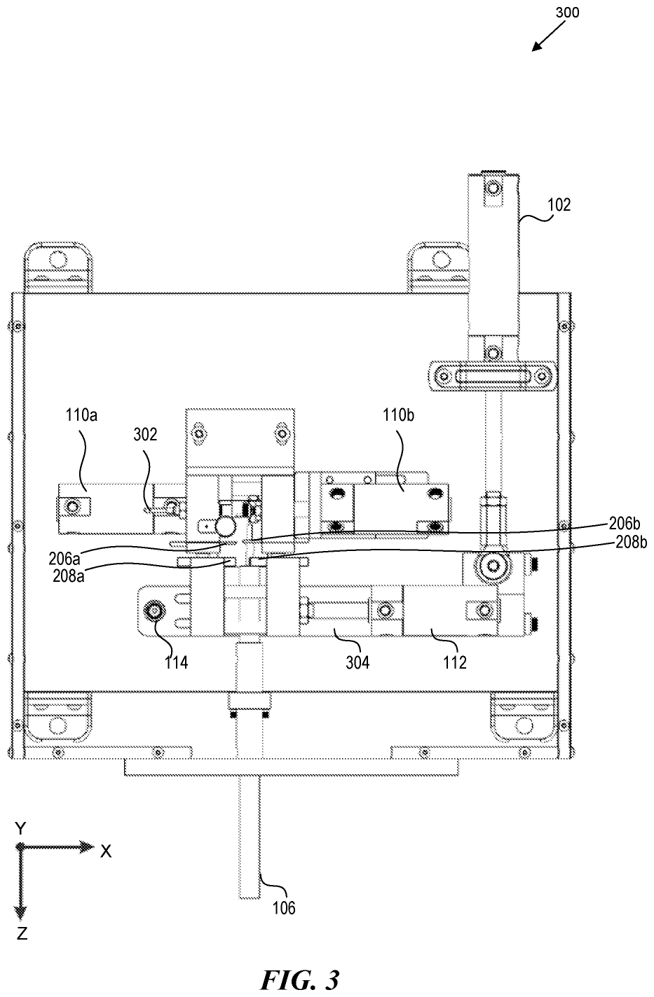

In the illustrated embodiment, a plurality of cutting actuators 110a and 110b, at least one clamping actuator 112, and at least one stripping actuator 102 are mounted to the mounting structure 108. Cutting actuator 110a and cutting actuator 110b may be mounted in a mirrored orientation where cutting actuator 110b is rotated 180 degrees from cutting actuator 110a. Cutting actuator 110a and cutting actuator 110b may exert an equal and opposite force during the actuation process. Cutting actuator 110a and clamping actuator 112 are mounted in parallel, allowing the clamping actuator 112 to exert a force in the same direction as at least one cutting actuator 110a. The stripping actuator 102 is mounted perpendicular to the cutting actuator 110a to exert a force perpendicular to the cutting actuator 110a. Mounting clip 120 mounts the stripping actuator 102 to the mounting plate 108, preventing movement during the actuation process. As described in greater detail below with reference to FIG. 3, when the stripping actuator 102 exerts a force during the actuation process, clamping actuator 112 is pivoted around the pivot point 114, causing the insulation to be stripped from cable 106.

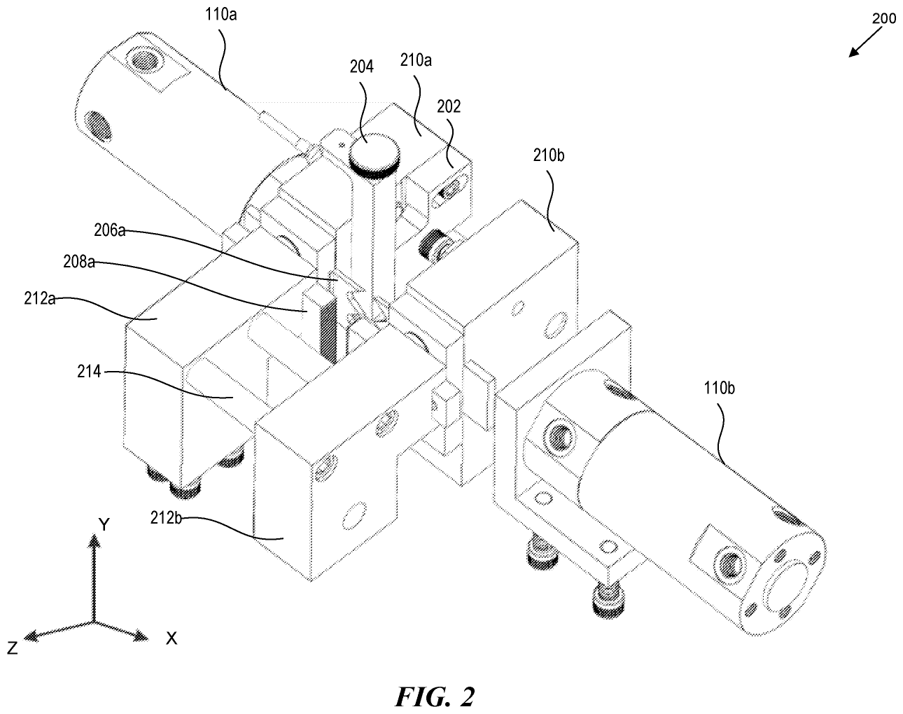

FIG. 2 is an isometric perspective view of the cutting system 200. The cutting system 200 includes cutting mechanism 210 and clamping mechanism 212. Cutting mechanism 210 includes one or more cutting blades 206a. For example, cutting mechanism 210 may include cutting blade 206a and cutting blade 206b, which are mirrored to each other to cut the inner insulation of cable 106 (FIG. 1) without damaging the conductors or wires. In some embodiments, cutting blade 206a and cutting blade 206b contain two or more notches or cutting channels to cut the inner insulation from a multiple conductor cable. For example, the number of notches in cutting blade 206a and cutting blade 206b corresponds to the maximum number of conductors that can be stripped simultaneously. Cutting actuator 110a and cutting actuator 110b may be actuated simultaneously to cut the inner insulation layer from cable 106 (FIG. 1) evenly, preventing damage to the conductor or wire. Cutting actuator 110a and cutting actuator 110b remain in an extended position after the actuation process until the entire cable stripping process is complete.

In some embodiments, one or more clamping mechanisms 212 secure cable 106 (FIG. 1) in place, preventing cable 106 (FIG. 1) from moving during the stripping process. Clamping mechanism 212 includes one or more clamping blocks 208a. Clamping block 208a and clamping block 208b may secure cable 106 (FIG. 1) at the filler fiber layer. In some embodiments, clamping block 208a and clamping block 208b contain ridged barbs, knurling, or hardened teeth to grip cable 106 (FIG. 1) and prevent cable 106 (FIG. 1) from moving. In some embodiments, a single actuator generates the clamping force required to secure cable 106 (FIG. 1) in place. One clamping mechanism 212 may be rigidly mounted to the mounting structure 108 (FIG. 1), while a second clamping mechanism 212 may slide on rods 214 when the force exerted by the clamping actuator 112 (FIG. 1) when the actuation process occurs.

In some embodiments, a set point mechanism 202 determines the distance from the end of cable 106 (FIG. 1) that the cutting blade 206a and cutting blade 206b cut. The set point mechanism may determine the distance cable 106 (FIG. 1) is inserted into the cable stripping mechanism. In some embodiments, the set point mechanism 202 sets the maximum cut length of cable 106 (FIG. 1), while the set point block 204 reduces the cut length set by the set point mechanism 202. The set point block 204 may attach to the set point mechanism 202 with magnets. In some embodiments, multiple set point blocks 204 increase or decrease the cutting distance, allowing different lengths of cable 106 (FIG. 1) to be stripped without adjusting the set point mechanism.

FIG. 3 is an above-facing view of the cable stripping mechanism. The proximity switch 302 may determine when the clamping actuator 112 begins the actuation process. The proximity switch 302 may be controlled by a control system. Cutting actuators 110a finish the cutting phase of the actuation process by cutting cable 106 with the cutting blades 206 and remaining locked in the extended cutting position. In some embodiments, the proximity switch begins the actuation process for the clamping actuator 112 when multiple cutting blades 206 make contact with each other. After a predetermined delay, the control system causes the clamping actuator 112 to perform the clamping phase of the actuation process. Clamping actuator 112 remains in the clamped position until the stripping process is complete.

The clamping actuator 112 is mounted to a pivot plate 304. In some embodiments, pivot plate 304 may be mounted on one end to the pivot point 114 and the stripping actuator 102 on the opposite end. The pivot plate 304 rotates about the pivot point 114 when the stripping actuator 102 performs the actuation process. The process of rotating the clamping actuator 112 in the clamped position causes the inner insulation layer of cable 106 to be stripped or removed off the conductor or wire. During this process, the cut portion of the inner insulation layer is removed due to the cutting blades 206 preventing the inner insulation layer from moving with cable 106 as it is pivoted around the pivot point 114.

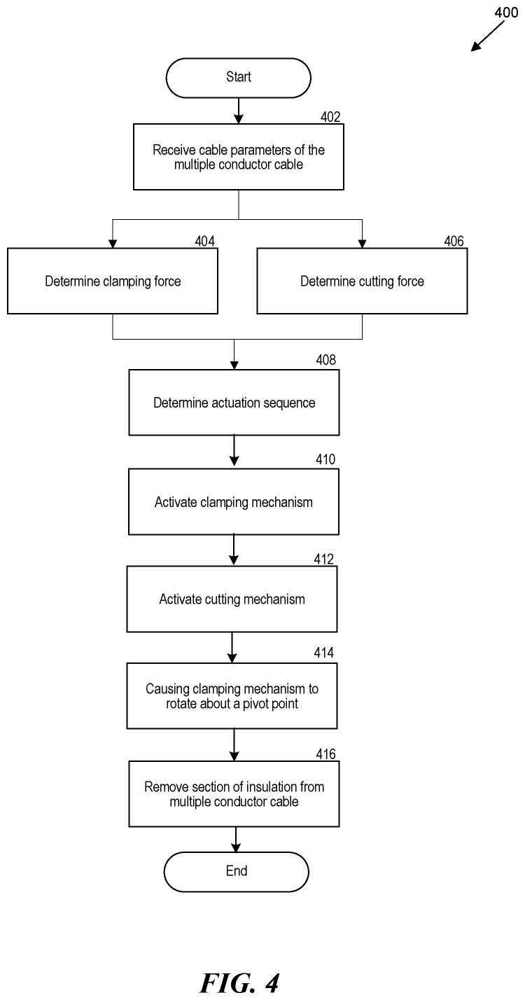

FIG. 4 is a flow diagram that illustrates a process 400 performed by the control system for stripping an insulation layer from a multiconductor cable. In one example, the control system includes at least one hardware processor and at least one non-transitory memory storing instructions, which, when executed by the at least one hardware processor, cause the control system to perform the process 400.

At 402, the control system receives cable parameters of the multiple conductor cable. The cable parameters may include a cable diameter and a conductor amount. In one example, the control system has a user interface capable of displaying the cable parameters, where the user interface may be wirelessly coupled to or attached to the system. At 404, the control system determines the clamping force of the clamping mechanism based on the received cable parameters. For example, the clamping force may be adjusted based on the received cable gauge or number of conductors in the cable. At 406, the control system determines the cutting force of the cutting mechanism based on the received cable parameters. For example, the cutting force may be adjusted based on the received cable gauge or number of conductors in the cable. At 408, the control system determines the actuation sequence. For example, the order of the actuation sequence can be determined by the cable parameters and the determined clamping force and cutting force.

At 410, the control system activates the clamping mechanism. At 412, the control system activates the cutting mechanism. In one example, the system has one or more sensors configured to determine the cable parameters of the multiconductor cable, where the control system adjusts a cutting depth of the cutting mechanism based on the cable parameters received from at least one sensor. The control system may adjust a force applied by at least one actuator based on the cable parameters received from at least one sensor.

At 414, the control system causes the clamping mechanism to rotate about a pivot point, where the rotation is caused by an activation of one or more actuators. In one example, the control system may determine the actuation sequence of the plurality of actuators, where at least one actuator activates at a predetermined different time from at least one other actuator, and the at least one actuator causes the at least one clamping mechanism to rotate about the pivot point.

At 416, the control system removes a section of insulation from the multiple conductor cable based on the rotation of the clamping mechanism. In one example, the system may have an alert system capable of detecting an error with the system. The error is detected by the one or more sensors and the error can occur when at least one sensor detects a difference in the received cable parameters compared to the measured cable parameters or when at least one sensor detects the need to replace at one part of the system. The control system may receive an alert message from the alert system. The control system may determine the severity of the error and correct the error. Correcting the error may include halting the system or adjusting a system parameter to correct the error.

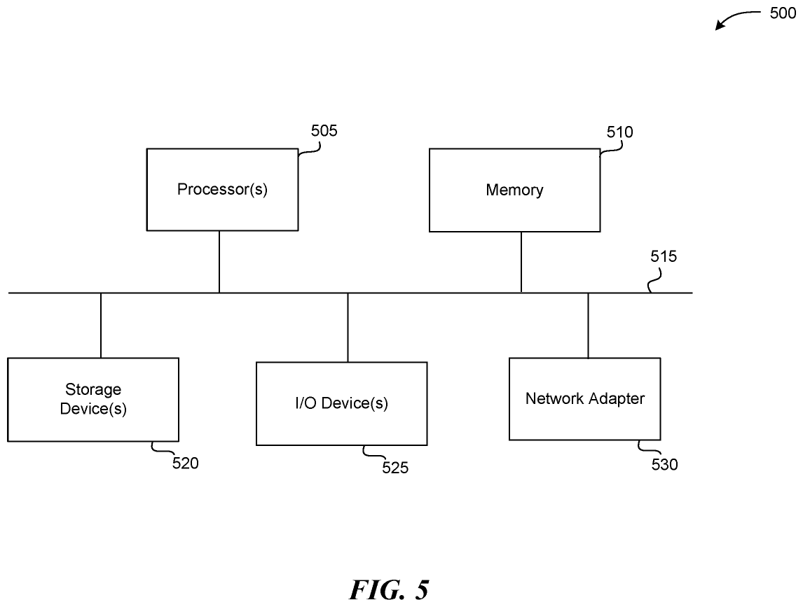

FIG. 5 is a block diagram of a computer system as may be used to implement features of the disclosed embodiments. The computer system 500 may be used to implement any of the entities, components or services depicted in the examples of the foregoing figures (and any other components described in this specification). The computer system 500 may include one or more central processing units (“processors”) 505, memory 510, input/output devices 525 (e.g., keyboard and pointing devices, display devices), storage devices 520 (e.g., disk drives), and network adapters 530 (e.g., network interfaces) that are connected to an interconnect 515. The interconnect 515 is illustrated as an abstraction that represents any one or more separate physical buses, point to point connections, or both connected by appropriate bridges, adapters, or controllers. The interconnect 515, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Components (IEEE) standard 1394 bus, also called “Firewire”.

The memory 510 and storage devices 520 are computer-readable storage media that may store instructions that implement at least portions of the described embodiments. In addition, the data structures and message structures may be stored or transmitted via a data transmission medium, such as a signal on a communications link. Various communications links may be used, such as the Internet, a local area network, a wide area network, or a point-to-point dial-up connection. Thus, computer readable media can include computer-readable storage media (e.g., “non transitory” media) and computer-readable transmission media.

The instructions stored in memory 510 can be implemented as software and/or firmware to program the processor(s) 505 to carry out actions described above. In some embodiments, such software or firmware may be initially provided to the computer system 500 by downloading it from a remote system through the computer system 500 (e.g., via network adapter 530).

This disclosure is not intended to be exhaustive or to limit the present technology to the precise forms disclosed herein. Although specific embodiments are disclosed herein for illustrative purposes, various equivalent modifications are possible without deviating from the present technology, as those of ordinary skill in the relevant art will recognize. In some cases, well-known structures and functions have not been shown and/or described in detail to avoid unnecessarily obscuring the description of the embodiments of the present technology. Although steps or methods may be presented herein in a particular order, in alternative embodiments the steps may have another suitable order. Similarly, certain aspects of the present technology disclosed in the context of particular embodiments can be combined or eliminated in other embodiments. Furthermore, while advantages associated with certain embodiments may have been disclosed in the context of those embodiments, other embodiments may also exhibit such advantages, and not all embodiments need necessarily exhibit such advantages or other advantages disclosed herein to fall within the scope of the present technology.

Certain aspects of the present technology may take the form of computer-executable instructions, which can be executed by one or more processors. In some embodiments, the one or more processors are specifically programmed, configured, or constructed to perform one or more of these computer-executable instructions. Furthermore, some aspects of the present technology may take the form of data (e.g., non-transitory data) stored on memory or stored or distributed on other non-transitory computer-readable media, including magnetic or optically readable or removable computer discs, as well as media distributed electronically over networks. Accordingly, data structures and transmissions of data particular to aspects of the present technology are encompassed within the scope of the present technology. The present technology also encompasses methods of both programming computer-readable media to perform particular steps and executing the steps.

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the terms “comprising” and the like may be used herein to mean including at least the recited feature(s) such that any greater number of the same feature(s) and/or one or more additional types of features are not precluded. Directional terms, such as “upper,” “lower,” “front,” “back,” “vertical,” and “horizontal,” may be used herein to express and clarify the relationship between various elements. It should be understood that such terms do not denote absolute orientation. Reference herein to “one embodiment,” “an embodiment,” or similar formulations means that a particular feature, structure, operation, or characteristic described in connection with the embodiment can be included in at least one embodiment of the present technology. Thus, the appearances of such phrases or formulations herein are not all referring to the same embodiment. Furthermore, various particular features, structures, operations, or characteristics may be combined in any suitable manner in one or more embodiments of the present technology.

I/We claim:

1. A system comprising:
a plurality of actuators operable to receive instructions and coordinate an actuation sequence;
a clamping mechanism,
wherein the clamping mechanism includes at least one of the plurality of actuators, and
wherein the clamping mechanism includes at least one clamping block;
a cutting mechanism,
wherein the cutting mechanism cuts an insulation layer of a multiple conductor cable, and
wherein the cutting mechanism includes at least one cutting blade; and
a control system comprising at least one controller, wherein the at least one controller comprises:
at least one hardware processor; and
at least one non-transitory memory storing instructions, which when executed by the at least one hardware processor, cause the system to:
receive cable parameters of the multiple conductor cable,
wherein the cable parameters include cable diameter and conductor quantity;
activate the clamping mechanism;
activate the cutting mechanism;
cause the clamping mechanism to rotate about a pivot point,
wherein the rotation is caused by an activation of one or more actuators; and
a section of insulation from the multiple conductor cable based on the rotation of the clamping mechanism.

2. The system of claim 1 further comprising:
a plurality of set point mechanisms,
wherein the set point mechanisms include a primary set point block and at least one quick set point block, and
wherein the set point block attaches to the primary set point block.

3. The system of claim 1, further comprising:
a user interface capable of displaying the cable parameters,
wherein the user interface is coupled to the control system.

4. The system of claim 1, further comprising:
one or more sensors configured to determine the cable parameters of the multiple conductor cable; and
the control system, the instructions further cause the system to:
adjust a cutting depth of the cutting mechanism based on the cable parameters received from the at least one sensor; and
adjust a force applied by the at least one actuator based on the cable parameters received from the at least one sensor.

5. The system of claim 1, wherein the multiple conductor cable contains:
the inner insulation layer;
a filler fiber layer; or
an outer insulation layer.

6. The system of claim 1, further comprising:
an alert system capable of detecting an error with the system,
wherein the error is detected by the one or more sensors, and
wherein the error can occur when at least one sensor detects a difference in the received cable parameters compared to the measured cable parameters; and
the control system, the instructions further cause the system to:
receive an alert message from the alert system;
determine the severity of the error; and
correct the error,
wherein correcting the error includes halting the system or adjusting a system parameter to correct the error.

7. The system of claim 1, wherein the control system instructions further cause the system to:
determine the actuation sequence of the plurality of actuators,
wherein at least one actuator activates at a predetermined time different from at least one other actuator, and
wherein the at least one actuator causes the at least one clamping mechanism to rotate about the pivot point.

8. An apparatus for stripping insulation from a multiple conductor cable comprising:
a plurality of actuators, the plurality of actuators operable to receive instructions and coordinate an actuation sequence;
a clamping mechanism,
wherein the clamping mechanism includes at least one of the plurality of actuators, and
wherein the clamping mechanism includes at least one clamping block; and
a cutting mechanism,
wherein the cutting mechanism cuts an insulation layer of a multiple conductor cable, and
wherein the cutting mechanism includes at least one cutting blade.

9. The apparatus of claim 8 further comprising:
a plurality of set point mechanisms,
wherein the set point mechanism includes a primary set point block and at least one quick set point block, and
wherein the set point block attaches to the primary set point block.

10. The apparatus of claim 8, further comprising:
a control system comprising a plurality of controllers, a non-transitory readable medium storing a program for managing the system, the program causes the apparatus to:
receive cable parameters of the multiple conductor cable,
wherein the cable parameters include cable diameter and conductor amount;
activate the clamping mechanism;
activate the cutting mechanism;
cause the clamping mechanism to rotate about a pivot point,
wherein the rotation is caused by an activation of one or more actuators; and
remove a section of insulation from the multiple conductor cable based on the rotation of the clamping mechanism.

11. The apparatus of claim 8, wherein the multiple conductor cable contains:
the inner insulation layer;
a filler fiber layer; or
an outer insulation layer.

12. The apparatus of claim 8, further comprising:
one or more sensors configured to determine the cable parameters of the multiconductor cable; and
the control system, the program further causes the apparatus to:
adjust a cutting depth of the cutting mechanism based on the cable parameters received from at least one sensor; and
adjust a force applied by at least one actuator based on the cable parameters received from at least one sensor.

13. The apparatus of claim 8, further comprising:
an alert system capable of detecting an error with the system,
wherein the error is detected by the one or more sensors, and
wherein the error can occur when at least one sensor detects a difference in the received cable parameters compared to the measured cable parameters; and
the control system, the program further causes the apparatus to:
receive an alert message from the alert system;
determine the severity of the error; and
correct the error,
wherein correcting the error includes halting the system or adjusting a system parameter to correct the error.

14. The apparatus of claim 8, wherein the control system further causes the apparatus to:
determine the actuation sequence of the plurality of actuators,
wherein at least one actuator activates at a time different from at least one other actuator, and
wherein the at least one actuator causes the at least one clamping mechanism to rotate about the pivot point.

15. A method for stripping insulation from a multiple conductor cable, comprising:
receiving cable parameters of the multiple conductor cable;
cutting an inner insulation layer at a predetermined distance from the end of the multiple conductor electrical wire with a cutting blade;
clamping a filler fiber layer of the multiple conductor electrical wire with a clamping mechanism;
rotating a clamped portion of the multiple conductor cable around a pivot point; and
stripping the inner insulation layer from the multiple conductor cable based on a rotation of the clamped portion of the multiple conductor cable,
wherein the inner insulation layer is removed from the multiple conductor cable.

16. The method of claim 15, wherein the cable parameters are received through a user interface.

17. The method of claim 15, wherein one or more sensors are configured to determine the cable parameters of the multiconductor cable, further comprising:
adjusting a cutting depth of the cutting mechanism based on the cable parameters received from at least one sensor; and
adjusting a force applied by at least one actuator based on the cable parameters received from at least one sensor.

18. The method of claim 15 wherein at least one actuator causes the rotating of the clamped portion of the multiple conductor cable.

19. The method of claim 15 wherein the multiple conductor cable contains:
the inner insulation layer;
a filler fiber layer; or
an outer insulation layer.

20. The method of claim 15 wherein a set point mechanism determines a predetermined cutting distance from the end of the multiple conductor cable.
